(19) United States
(12) Patent Application Publication
(10) Pub. No.: US 2016/0042758 A1
(43) Pub. Date: Feb. 11, 2016

(54) METHOD FOR DETERMINING PHASE DIFFERENCE OF TRACKING ERROR SIGNAL

(71) Applicant: QUANTA STORAGE INC., Taoyuan City (TW)

(72) Inventors: An-Te LIU, Taoyuan City (TW); Chuan-Tsung FENG, Taoyuan City (TW)

(73) Assignee: QUANTA STORAGE INC., Taoyuan City (TW)

(21) Appl. No.: 14/675,211

(22) Filed: Mar. 31, 2015

(30) Foreign Application Priority Data
Aug. 11, 2014 (CN) 201410391752.5

(51) Int. Cl. G11B 7/09

(52) U.S. Cl. CPC G11B 7/0903; G11B 7/0941

(57) ABSTRACT

A method for determining phase difference of tracking error (TE) signal is disclosed. The method includes following steps. An optical disc drive is activated to generate a TE signal. Amplitudes of the master push pull (MPP) signal, the secondary push pull (SPP) signal and the TE signal are measured. The phase difference between the MPP signal and the SPP signal of the TE signal is quickly calculated according to the law of cosine.

This application claims the benefit of People's Republic of China application Serial No. 201410391752.5, filed Aug. 11, 2014, the subject matter of which is incorporated herein by reference.

### BACKGROUND OF THE INVENTION

1. Field of the Invention

The invention relates in general to a method for controlling an optical disc drive, and more particularly to a method for determining phase difference which causes offset of tracking error (TE) signal during the tracking control of the optical disc drive.

2. Description of the Related Art

Optical disc drive focuses a light spot on an optical disc, receives a flux of the light reflected from the optical disc to form control signals, such as focusing error (FE) signal and tracking error (TE) signal, and controls the light spot to be focused on the optical disc and move along the groove so that data can be written to or read from the optical disc.

Refer to FIG. 1 and FIG. 2. FIG. 1 is a functional block diagram of an optical disc drive generating a TE signal according to prior art. FIG. 2 is a schematic diagram of a TE signal. When the optical disc drive of prior art performs tracking control with differential push pull (DPP), the pick-up head focuses a laser beam on a primary beam 1a and two secondary beams 1b and 1c. The primary beam 1a and the two secondary beams 1b and 1c are respectively projected on a groove 2 and two lands 3 of the rotating optical disc, and are reflected by the optical disc to form light spots 4a, 4b and 4c which are projected on a master optical transducer 5a and two secondary optical transducers 5b and 5c, respectively. The two lands 3 are located on two sides of the groove 2. Each of the optical transducers 5a, 5b and 5c is divided into two sub-units E and F with equal size, and the optical transducers 5a, 5b and 5c are further converted into electrical signals with corresponding magnitudes according to the received fluxes of the reflected light spots 4a, 4b and 4c. The electrical signal (E1-F1) formed by two sub-units of the master optical transducer 5a is master push pull (MPP) signal. The electrical signal (E2-F2) formed by the sub-unit of the secondary optical transducer 5b is first secondary push pull (SPP1) signal. The electrical signal (E3-F3) formed by the sub-unit of another secondary optical transducer 5c is second secondary push pull (SPP2) signal. After the electrical signal [(E2-F2)+(E3-F3)] of two sub-units of the two secondary optical transducers 5b and 5c is processed with gain value G to achieve the same magnitude as that of the MPP signal, a secondary push pull (SPP) signal is thus formed. Lastly, the MPP signal is deducted by the SPP signal (MPP−SPP) to form a tracking error (TE) signal used as a control signal for tracking the optical disc drive.

Normally, the pick-up head has a best angle θ for projecting master beam and secondary beam, such that the phase difference between the MPP signal and the SPP signal is 180°. As indicated in FIG. 2, when the TE signal formed by (MPP−SPP) reaches a maximum value, a best TE signal is obtained for controlling the primary beam 1a to move along the groove 2 so that marks can be correctly read from or written to the groove 2. However, the actual angle can be deviated from the best mechanical angle θ of the original design due to factors such as the pick-up head being defected or having poor quality, assembly offset between the guide rod and the spindle motor of the optical disc drive, eccentric optical disc, and relative position of the optical disc. Under such circumstance, the phase difference between the MPP signal and the SPP signal will not be equal to 180°, and the TE signal will be weakened (illustrated by dotted lines in FIG. 2). When the pick-up head performs tracking control based on the TE signal being equal to 0 rather than the zero point of the MPP (the real center of the track), the light spot will be offset and read/write errors will occur. Therefore, the optical disc drive has to determine and compensate the offset of phase difference, or use the information of phase difference to identify and correct the defects in the manufacturing process such that better TE signal can be obtained.

The method for determining phase difference of the TE signal of prior art is exemplified by Taiwanese Patent No. TW100112741. A phase difference curve is created according to an amplitude ratio of the MPP signal plus the SPP signal (MPP+SPP) vs the master push pull signal minus the SPP signal (MPP−SPP). For determining the phase difference of the TE signal, the MPP signal and the SPP signal are measured, the amplitude ratio (MPP+SPP)/(MPP−SPP) is calculated, and the phase difference can be quickly obtained with reference to the phase difference.

According to the prior art, the SPP signal has to be processed with gain adjustment using gain value G to achieve the same magnitude as that of the MPP signal before the TE signal can be formed. However, the gain value G of the optical disc drive is a limiting set value, and when the phase difference is abnormal, the SPP signal will contract, and make the difference between the SPP signal and the MPP signal too large to be compensated. Even when the SPP signal is processed with gain adjustment, the SPP signal still cannot achieve the same magnitude as that of the MPP signal. Therefore, the phase difference of the TE signal cannot be accurately compensated, and quality control cannot be performed to screen out defected optical disc drive, and the pick-up head will have tracking errors. Therefore, prior art still has many problems to resolve when it comes to the determination of phase difference of the TE signal.

### SUMMARY OF THE INVENTION

The invention is directed to a method for determining phase difference of TE signal. Amplitudes of MPP signal, SPP signal and TE signal are measured, such that phase difference between the MPP signal and the SPP signal can be quickly calculated according to the law of cosine regardless whether the SPP signal is processed with gain adjustment to achieve the same magnitude as that of the MPP signal.

To achieve the above object of the invention, the method for determining phase difference of TE signal of the invention includes following steps. Firstly, an optical disc drive is activated to generate a TE signal. Next, an amplitude of an MPP signal is measured. Then, an amplitude of an SPP signal is measured. Then, an amplitude of the TE signal is measured. Lastly, phase difference β between the MPP signal and the SPP signal value is calculated according to the law of cosine: cos β=[(MPP²+SPP²)−TE²]/[2MPP*SPP].

According to the method for determining phase difference of TE signal of the invention, phase difference between the MPP signal and the SPP signal is accurately measured regardless whether the SPP signal is processed with gain adjustment to achieve the same magnitude as that of the MPP signal. The SPP signal can be replaced by the first SPP signal or the SSP2 to determine the phase difference.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a functional block diagram of an optical disc drive generating a TE signal according to prior art.

FIG. 2 is a schematic diagram of a TE signal according to prior art.

FIG. 3 is a schematic diagram of signals measured when the phase difference is equal to 0°.

FIG. 4 is a schematic diagram of signals when the phase difference is equal to 30°.

FIG. 5 is a schematic diagram of signals when the phase difference is equal to 90°.

FIG. 6 is a schematic diagram of signals when the phase difference is equal to β.

FIG. 7 is a schematic diagram of amplitude vectors of signals when the phase difference is equal to β.

FIG. 8 is a flowchart of a method for determining the phase difference of the TE signal of the invention.

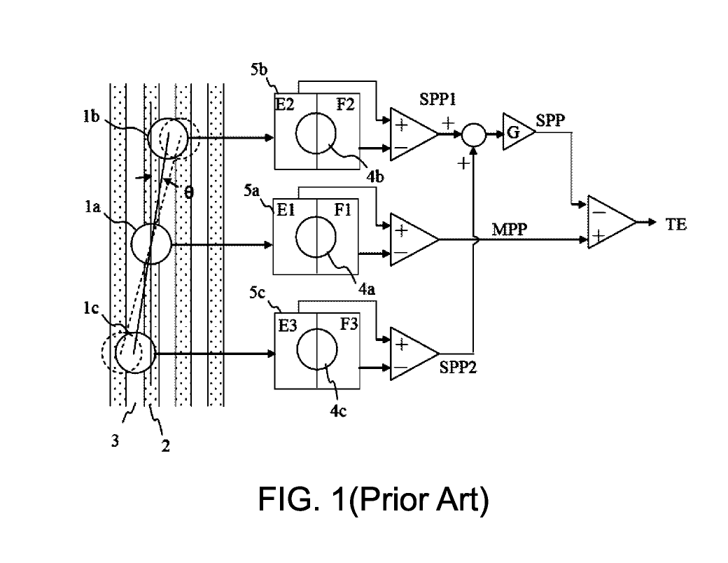

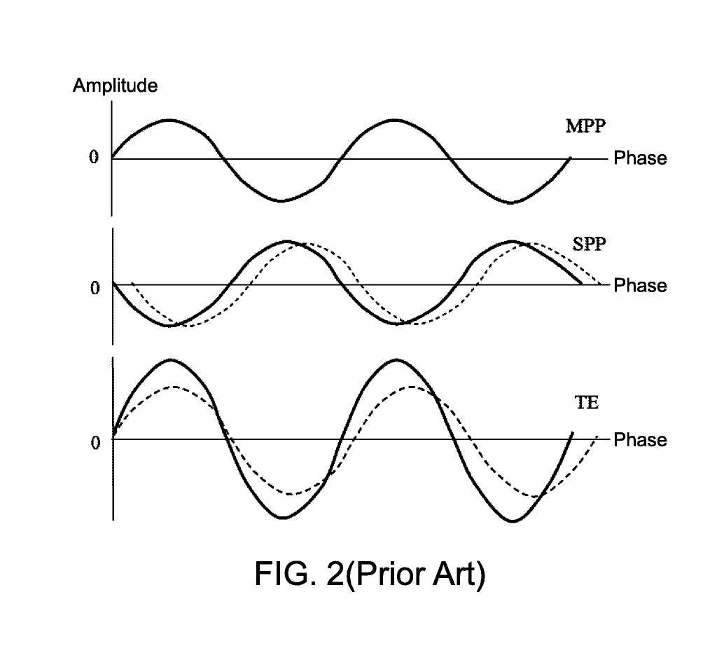

### DETAILED DESCRIPTION OF THE INVENTION

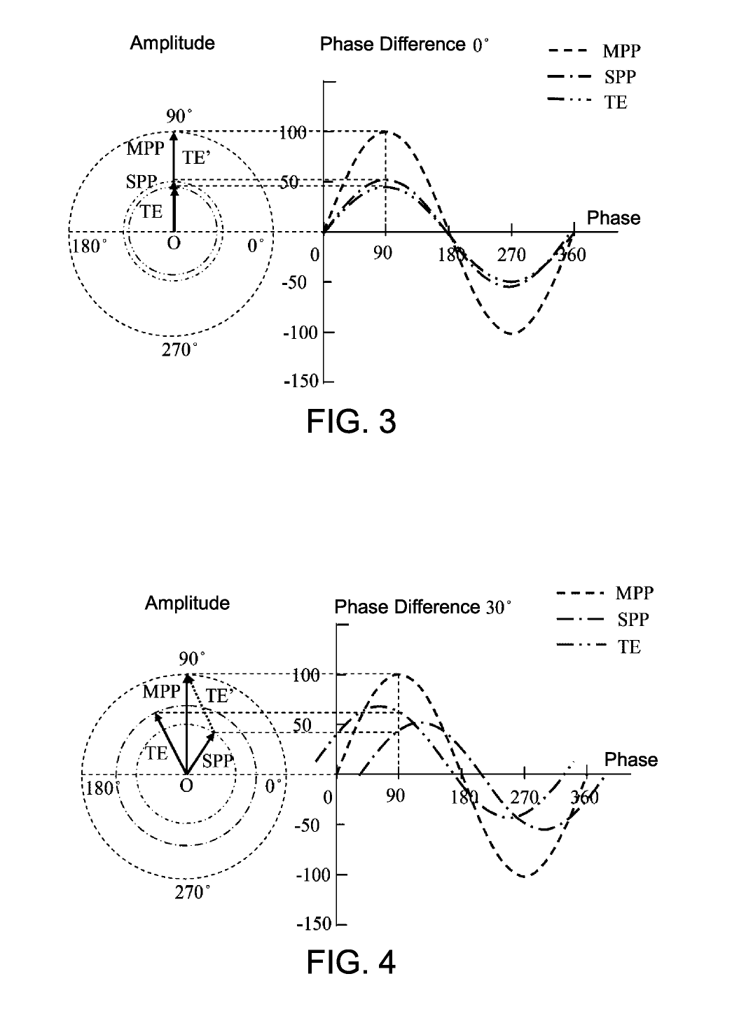

Referring to FIG. 3 to FIG. 5, schematic diagrams of MPP signal, SPP signal and TE signal are measured when the phase difference is equal to °, 30° and 90° respectively. The optical disc drive focuses a light spot on a rotating optical disc, and receives a flux of the light reflected from the optical disc to form a master push pull (MPP) signal, a first secondary push pull (SPP1) signal and a second secondary push pull (SPP2) signal. Then, the SPP1 signal and the SPP2 signal are combined to form a secondary push pull (SPP) signal, and the MPP signal is deducted by the SPP signal to form a tracking error (TE) signal used as a control signal for tracking the optical disc drive. The MPP signal, the SPP signal and the TE signal are periodic sine waves. The periodic change of the periodic sine wave is represented by using the amplitude of the periodic sine wave as an amplitude vector rotating around the central point for 360°, wherein the amplitude is equal to a half of the vertical distance from the crest to the trough of the sine wave. The vertical component of the projection of the amplitude vector on the vertical axis of each rotation angle forms a variation chart of signal magnitudes within a period. During the measurement of the signal, the MPP signal and the SPP signal are not processed with gain adjustment, so the MPP signal and the SPP signal normally have different amplitudes. Specific phase difference, such as 0°, 30° and 90°, between the MPP signal and the SPP signal is selected, and the MPP signal, the SPP signal and the TE signal are measured to form a periodic sine wave. When the phase of the MPP signal is equal to 90°, relative positions between amplitude vectors of the MPP signal, the SPP signal and the TE signal are measured and shown on the variation chart of signal magnitudes.

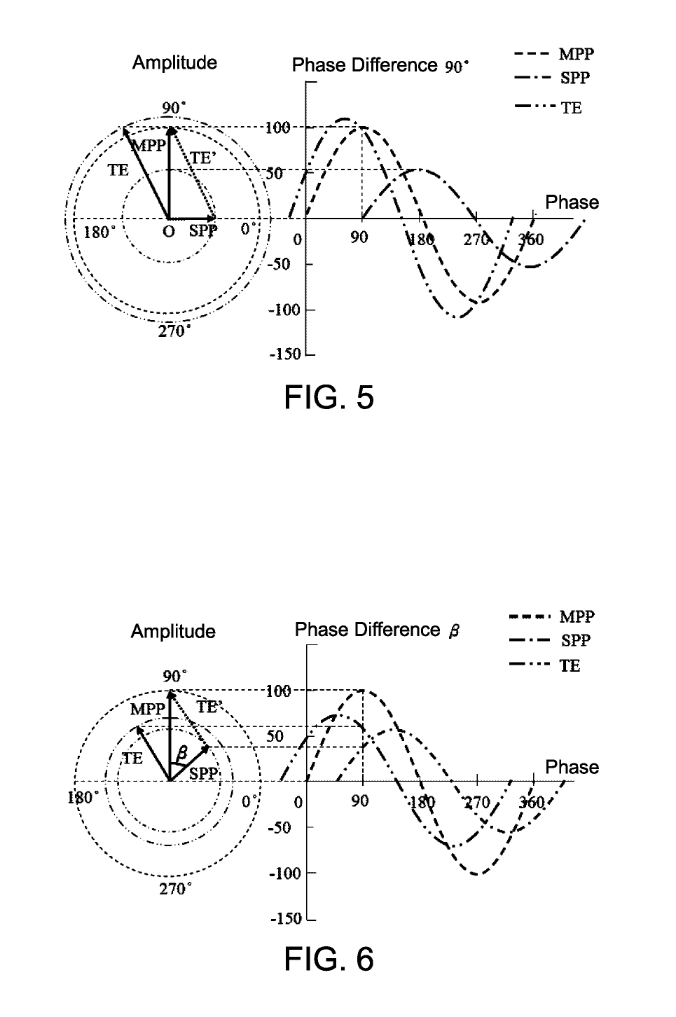

As indicated in FIG. 3, the phase difference between the MPP signal and the SPP signal is 0°. When the phase of the MPP signal is 90°, the amplitude vectors of the MPP signal, the SPP signal and the TE signal are measured. Since the signal TE=MPP−SPP, and the amplitude vector of the MPP signal minus the amplitude vector of the SSP signal is equal to the amplitude vector of the TE′ signal, the amplitude vector of the TE signal is equal to the amplitude vector of the MPP signal minus the amplitude vector of the SSP signal. As indicated in FIG. 4, the phase difference between the MPP signal and the SPP signal is equal to 30°. When and the phase of the MPP signal is 90°, the amplitude vectors of the MPP signal, the SPP signal and the TE signal are measured, the angle between the amplitude vector of the MPP signal and the amplitude vector of the SSP signal is equal to phase difference of 30°, the amplitude vector of the TE signal is shifted to the amplitude vector of the TE′ signal, and the amplitude vector of the MPP signal minus the amplitude vector of the SSP signal is equal to the amplitude vector of the TE signal. As indicated in FIG. 5, the phase difference between the MPP signal and the SPP signal is equal to 90°. When and the phase of the MPP signal is 90°, the amplitude vectors of the MPP signal, the SPP signal and the TE signal are measured, the angle formed between the amplitude vector of the MPP signal and the amplitude vector of the SSP signal is equal to phase difference of 90°, the amplitude vector of the TE signal is shifted to the amplitude vector of the TE′ signal, and the amplitude vector of the MPP signal minus the amplitude vector of the SSP signal is equal to the amplitude vector of the TE signal.

As indicated in FIG. 6, a schematic diagram of MPP signal, SPP signal and TE signal when the phase difference is equal to β is shown. Based on the measurement of each specific phase difference, the amplitude vector of the MPP signal minus the amplitude vector of the SSP signal is equal to the amplitude vector of the TE signal. Therefore, for any phase difference β, when the phase of the MPP signal is 90°, the amplitude vectors of the MPP signal, the SPP signal and the TE signal are measured, and the angle formed between the amplitude vector of the MPP signal and the amplitude vector of the SSP signal is equal to the phase difference β. The amplitude vector of the TE signal is shifted to the amplitude vector of the TE′ signal, such that the amplitude vector of the MPP signal minus the amplitude vector of the SSP signal is equal to the amplitude vector of the TE signal, and the amplitude vector of the MPP signal, the amplitude vector of the SSP signal and the amplitude vector of the TE signal form a triangle. Based on the law of cosine: cos β=[(MPP²+SPP²)−TE²]/[2MPP*SPP], the phase difference β of the angle formed between the amplitude vector of the MPP signal and the amplitude vector of the SSP signal can be calculated according to the lengths of the amplitude vector of the MPP signal, the amplitude vector of the SPP signal and the amplitude vector of the TE signal.

In the above embodiments, the amplitude vector of the MPP signal and the amplitude vector of the SPP signal have different magnitudes but are not processed with gain adjustment. However, the above method for calculating phase difference according to the law of cosine is also applicable to the amplitude vector of the MPP signal and the amplitude vector of the SPP signal, wherein the MPP signal and the SPP signal achieve the same magnitude by way of gain adjustment. Therefore, the invention is capable of determining phase difference by balancing signal gains.

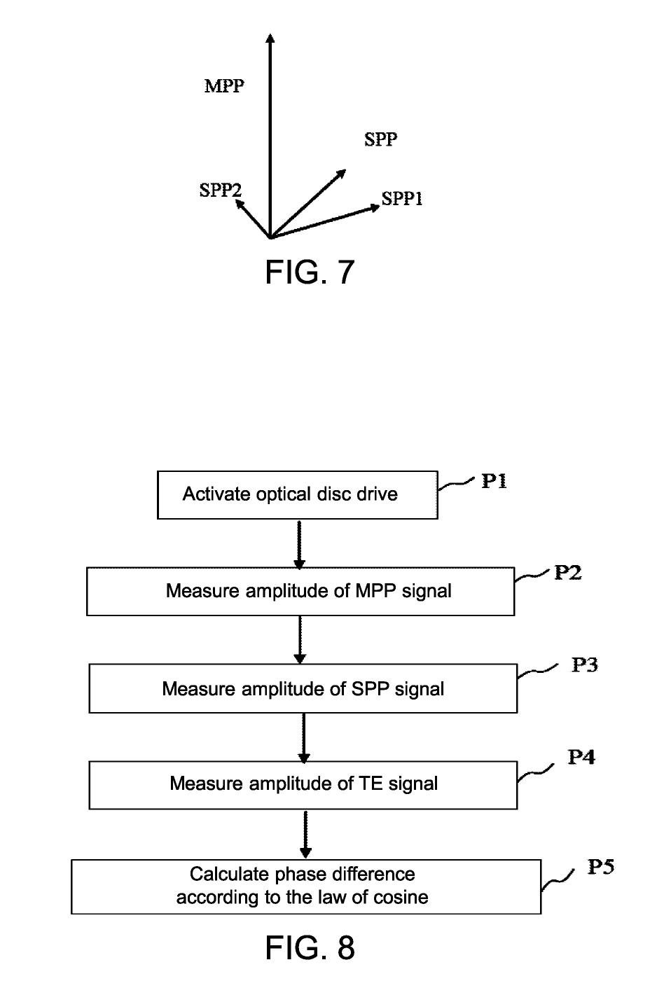

Referring to FIG. 7, a schematic diagram of amplitude vectors of MPP signal and SPP signal, SPP1 signal and SPP2 signal is shown. In the above embodiments, phase difference is calculated according to the amplitude vector of the MPP signal and the amplitude vector of the SPP signal, and the amplitude vector of the SPP signal is equal to the amplitude vector of the SPP1 signal plus the amplitude vector of the SPP2 signal. The amplitude vector of the SPP1 signal and the amplitude vector of the SPP2 signal are components of the amplitude vector of the SPP signal. The phase difference between the MPP signal and the SPP1 signal or the SPP2 signal can be obtained by replacing the SPP signal with the SPP1 signal or the SPP2 signal. Thus, how far the single-sided beam signal deviates from the best mechanical angle θ can be reflected and the abnormal mechanism of the optical disc drive can be adjusted.

Referring to FIG. 8, a flowchart of a method for determining the phase difference of the TE signal of the invention is shown. The method for determining the phase difference includes following steps: Firstly, the method begins at step P1, an optical disc drive is activated to generate a TE signal. Next, the method proceeds to step P2, an amplitude of an MPP signal is measured. Then, the method proceeds to step P3, an amplitude of an SPP signal is measured. Then, the method proceeds to step P4, an amplitude of a TE signal is measured. Then, the method proceeds to step P5, phase difference β between the MPP signal and the SPP signal is calculated according to the law of cosine: cos β=[(MPP²+SPP²)−TE²]/[2MPP*SPP].

According to the method for determining phase difference of TE signal of the invention, the phase difference of the optical disc drive TE signal can be determined according to the lengths of the amplitude vector of the MPP signal, the amplitude vector of the SPP signal and the amplitude vector of the TE signal (that is, the amplitudes of the TE signal, the MPP signal and the SPP signal), and the phase difference between the MPP signal and the SPP signal can be calculated according to the law of cosine and used for compensating the TE signal or for controlling the quality of the optical disc drive and screening out defected products.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining a phase difference of a tracking error signal, comprising:
activating an optical disc drive to generate the tracking error signal;
measuring an amplitude of a master push pull signal;
measuring an amplitude of a secondary push pull signal;
measuring an amplitude of the tracking error signal;
calculating the phase difference according to the law of cosine: cos β=[(MPP²+SPP²)−TE²]/[2MPP*SPP], wherein β indicates the phase difference, MPP indicates the amplitude of the master push pull signal, SPP indicates the amplitude of the secondary push pull signal, and TE indicates the amplitude of the tracking error signal.

2. The method for determining phase difference of tracking error signal according to claim 1, wherein the phase difference is a phase difference between the master push pull signal and the secondary push pull signal.

3. The method for determining phase difference of tracking error signal according to claim 1, wherein the secondary push pull signal is not processed with signal gain to have same magnitude as that of the master push pull signal.

4. The method for determining phase difference of tracking error signal according to claim 1, wherein the secondary push pull signal is processed with signal gain to have the same magnitude as that of the master push pull signal.

5. The method for determining phase difference of tracking error signal according to claim 1, wherein the secondary push pull signal is a first secondary push pull signal.

6. The method for determining phase difference of tracking error signal according to claim 1, wherein the secondary push pull signal is a second secondary push pull signal.
